(19) United States
(12) Patent Application Publication
(10) Pub. No.: US 2009/0233640 A1
(43) Pub. Date: Sep. 17, 2009

(54) MOBILE TERMINAL DEVICE

(75) Inventors: Takeshi Kurihara, Kanagawa (JP); Makoto Sasaki, Kanagawa (JP); Kouichiro Shiraishi, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/720,675

(22) PCT Filed: Dec. 2, 2005
(86) PCT No.: PCT/JP05/22208

§ 371 Date: Jun. 1, 2007

(30) Foreign Application Priority Data
Dec. 3, 2004 (JP) 2004-350970

(51) Int. Cl. H04M 1/00

(52) U.S. Cl. 455/550.1

(57) ABSTRACT

The present invention aims at providing a mobile terminal device that is capable of improving user's convenience in checking a utilization history of services that utilize a noncontact IC card function. A mobile terminal device of the present invention into which a noncontact IC 2 that is available in various services is installed, includes a controlling portion 1 for acquiring utilization conditions of various services stored in the noncontact IC 2 from the noncontact IC 2, a memory 4 for storing acquired utilization conditions of various services, a displaying portion 6 for outputting the utilization conditions of various services stored in the memory 4, and a sensing portion 3 for outputting a timing signal to the controlling portion 1 to acquire the utilization conditions of various services, wherein the controlling portion 1 acquires the utilization conditions of various services stored in the noncontact IC 2 at a point of time when the timing signal is input from the sensing portion 3.

### TECHNICAL FIELD

The present invention relates to a mobile terminal device in which a noncontact IC is installed and, more particularly, a mobile terminal device capable of checking a utilization history of services that are available by the noncontact IC.

### BACKGROUND ART

Nowadays various services utilizing the noncontact IC card are provided. For example, charge adjustment in a shop or a vending machine, fare adjustment in a transportation means such as a railway, a bus, or the like, access management of attendances in various halls, and the like may be listed.

Up to now, in order to check the utilization history of these services, e.g., available sum of money, application purpose, available balance/available point, access status or the like, the user of the noncontact IC card must get a bill every service, cause a noncontact IC card reader to display the utilization history read by the reader, cause a server connected to the noncontact IC card reader to transmit a mail containing information of the utilization history to the user of the noncontact IC card, or the like (see Patent Literature 1). For this reason, in some cases the user of the noncontact IC card could not check the utilization history all the time, or it took a lot of time and effect for the user to check the utilization history.

At present, the mobile terminal device into which an IC chip for implementing a noncontact IC card function (This IC chip will be referred to as a “noncontact IC” hereinafter) is installed has been developed. The user can check the utilization history of the noncontact IC card function at any point of time by utilizing the function of the mobile terminal device. In displaying the utilization history on a display, for example, this mobile terminal device executes the processes of reading the data corresponding to the utilization history from a memory of the noncontact IC and displaying the utilization history based on the read data on the display, based on the application that is started to deal with the service whose utilization history should be displayed. The user does not check the utilization history via the noncontact IC reader, the server connected to the noncontact IC reader, or the like, but checks directly the utilization history read from the noncontact IC. Therefore, the user can check the utilization history at any time by utilizing this mobile terminal device.

### Patent Literature 1: JP-A-2003-85608

### DISCLOSURE OF THE INVENTION

### Problems that the Invention is to Solve

However, in the above mobile terminal device, the application for reading the data corresponding the service must be started one by one every time when the utilization history of the service utilizing the noncontact IC card function is displayed. Therefore, it takes much time to display the utilization history on the display. Also, in checking the utilization history in the overall services in such a situation that a plurality of services utilizing the noncontact IC card function are present, it takes much more time to check the utilization history as the number of used services is increased.

Also, the above mobile terminal device is constructed such that, in displaying the utilization history of the service utilizing the noncontact IC card function, the utilization history should be read from the memory of the noncontact IC by the different application every service to display on the display. For this reason, it was difficult to display at the same time the application histories of plural services.

The present invention has been made in view of the above circumstances, and it is an object of the present invention to provide a mobile terminal device capable of improving user's convenience in checking a utilization history of services that utilize a noncontact IC card function.

### Means for Solving the Problems

A mobile terminal device of the present invention, having a noncontact IC which is available in various services, comprising:

an acquiring unit for acquiring utilization conditions of various services stored in the noncontact IC;
a storing unit for storing acquired utilization conditions of various services;
an outputting unit for outputting the utilization conditions of various services stored in the storing unit; and

a timing notifying unit for outputting a timing signal to the acquiring unit to acquire the utilization conditions of various services;

wherein the acquiring unit acquires the utilization conditions of various services stored in the noncontact IC at a point of time when the timing signal is input from the timing notifying unit.

In the mobile terminal device equipped with the noncontact IC in the prior art, in checking the application condition of each service that can be used by the noncontact IC card function, the application for reading the data corresponding the service must be started one by one every time when the user of the mobile terminal device executes the operation to output the application condition of each service and the data regarding the application condition of each service are read from the noncontact IC and output. In contrast, according to this configuration, the application for reading the data corresponding each service is started every time when the noncontact IC is utilized in any service, then the data regarding the application condition of each service are read from the noncontact IC and stored in the storing portion of the mobile terminal, and then the stored data regarding the application condition of each service are output when the user of the mobile terminal device executes the operation to output the application condition of the service. Therefore, a time required to output the application condition of each service from the operation of the user of the mobile terminal device can be reduced. Also, the data regarding the application conditions of plural services are read from the noncontact IC and stored. Therefore, the data of these application conditions can be easily managed and the application conditions of plural services can be displayed simultaneously.

Also, in the mobile terminal device of the present invention, the timing notifying unit outputs the timing signal at a point of time when the noncontact IC is utilized in various services.

Also, in the mobile terminal device of the present invention, the timing notifying unit outputs the timing signal at a point of time when the noncontact IC is utilized in various services predetermine number of times.

Also, in the mobile terminal device of the present invention, the timing notifying unit outputs the timing signal at a previously scheduled time or at a previously set time interval.

According to this configuration, the data about the utilization condition of each service using the noncontact IC card function can be stored effectively in the storing portion of the mobile terminal device from the memory of the noncontact IC.

Also, the mobile terminal device of the present invention further includes a searching unit for searching the utilization conditions of various services, which coincide with predetermined conditions, from the utilization conditions of various services stored in the storing unit; and a setting unit for setting the predetermined conditions; wherein the outputting unit outputs the utilization conditions of various services searched by the searching unit.

According to this configuration, the user of the mobile terminal device can check effectively only the utilization condition of the service that the user wishes to check.

Also, in the mobile terminal device of the present invention, the outputting unit includes a mail sending unit, and the mail sending unit sends the utilization conditions of various services stored in the storing unit by a mail.

According to this configuration, the user can check easily the utilization condition of each service that utilizes the noncontact IC card function.

### ADVANTAGE OF THE INVENTION

According to the mobile terminal device of the present invention, convenience of the noncontact IC user in checking the utilization history of services that utilize the noncontact IC can be improved.

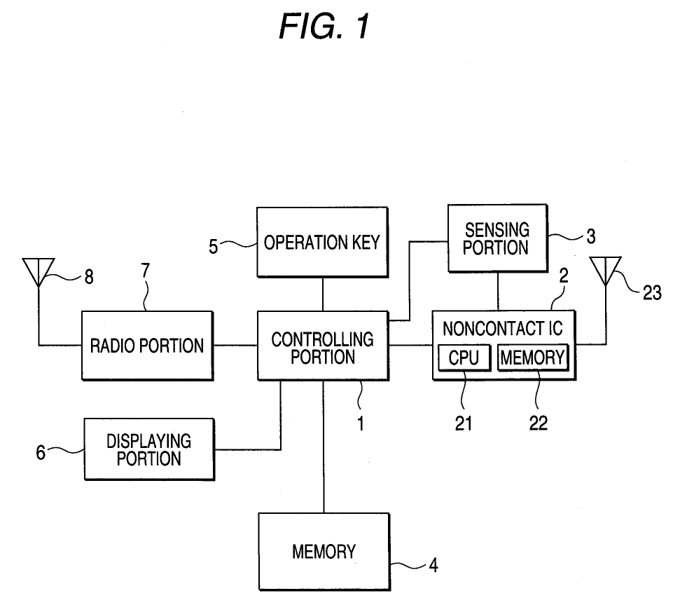

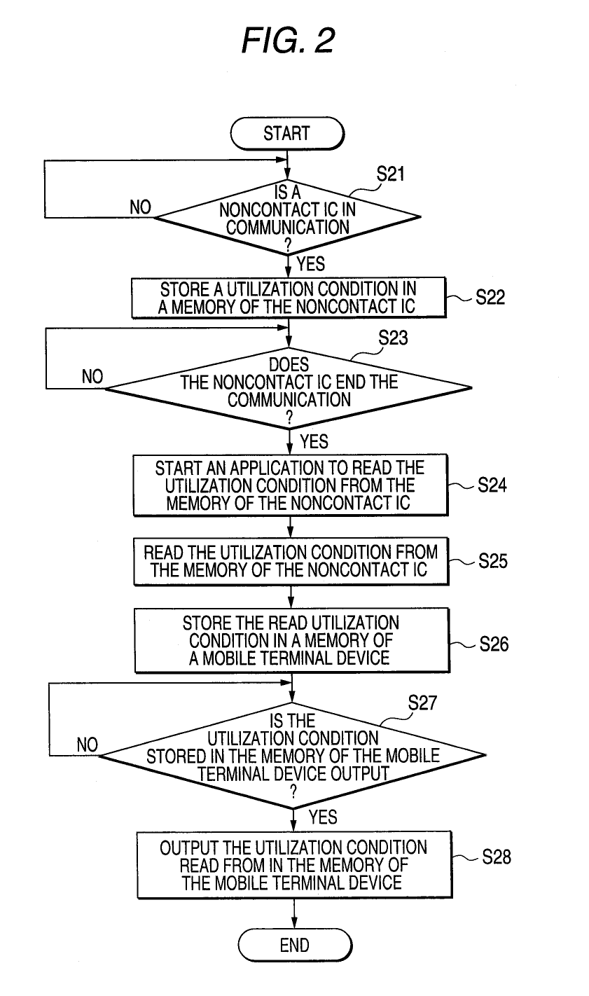

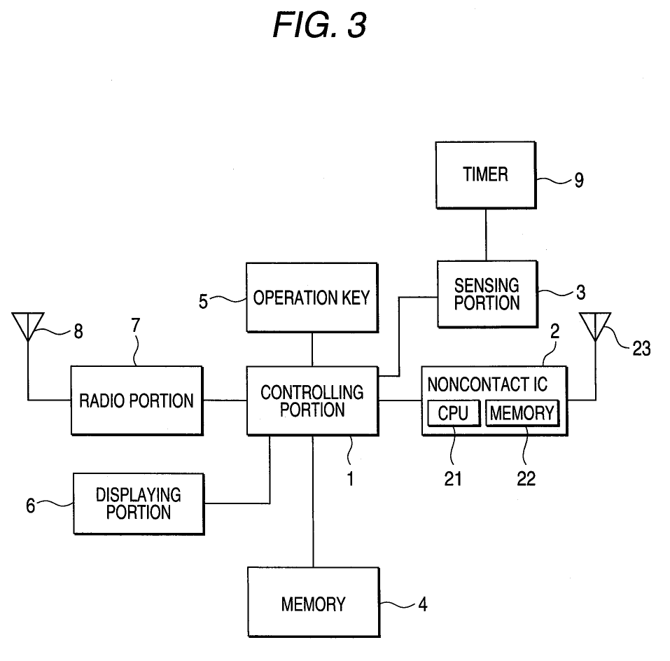

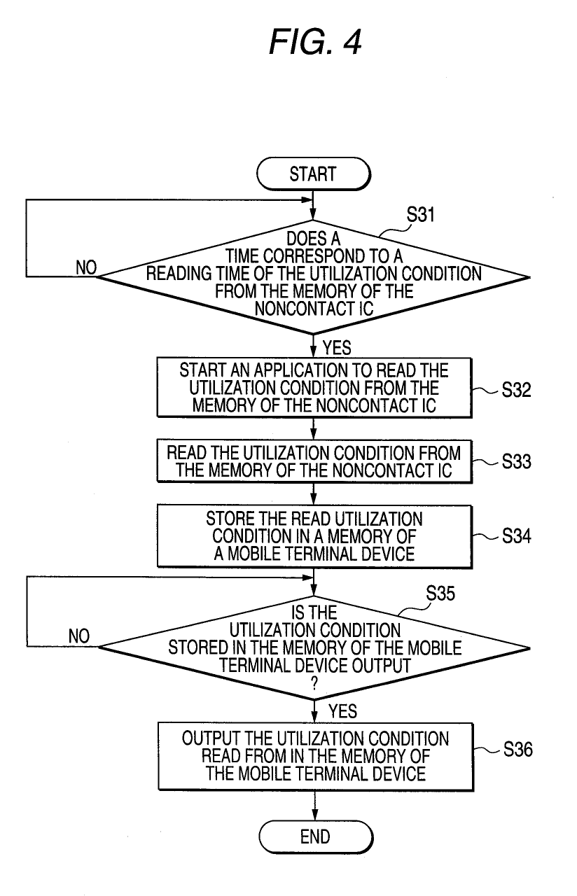

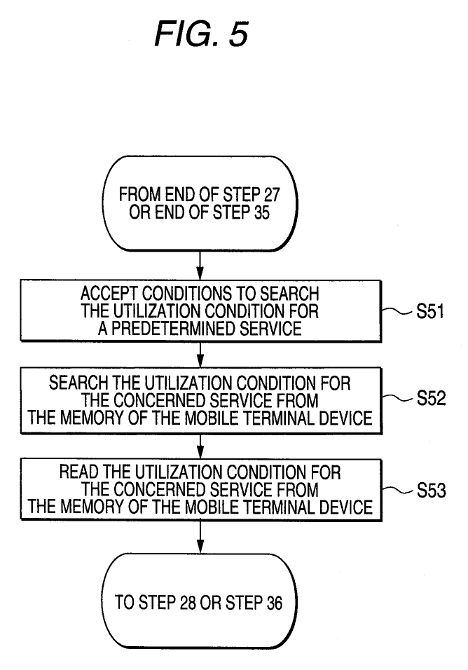

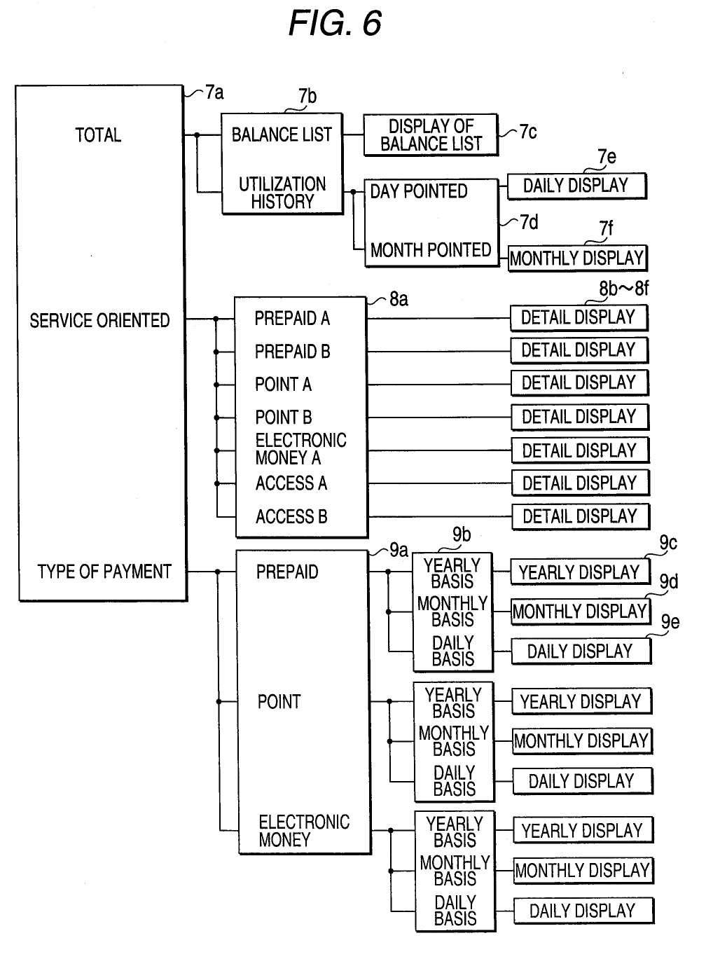

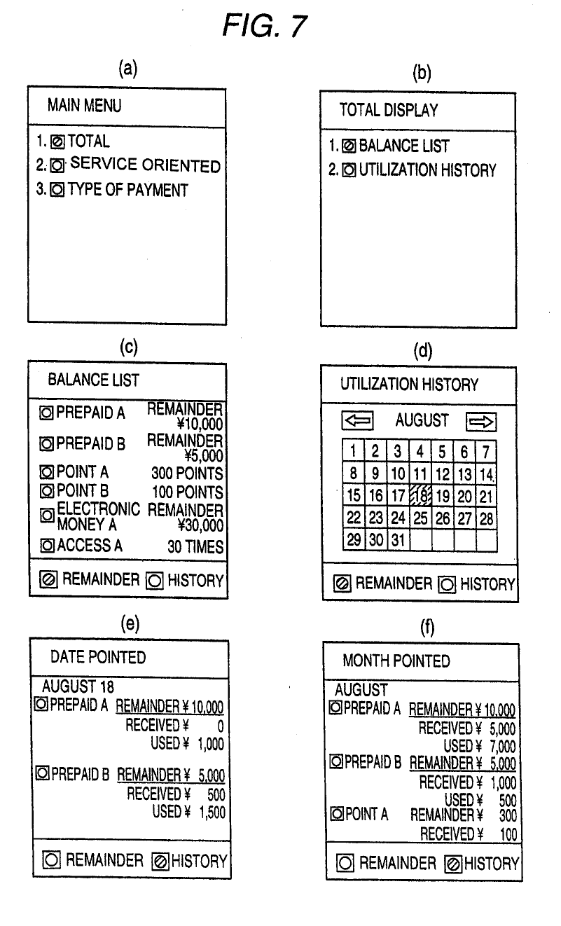

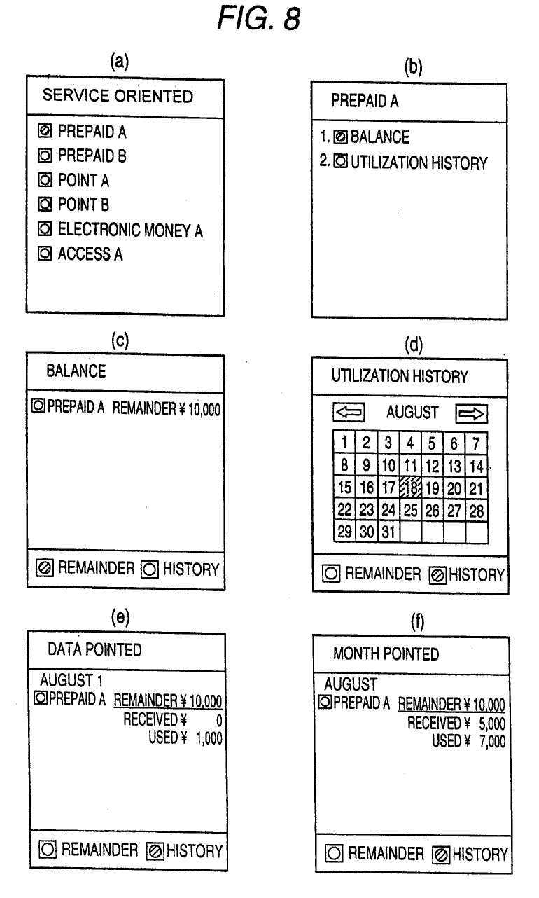

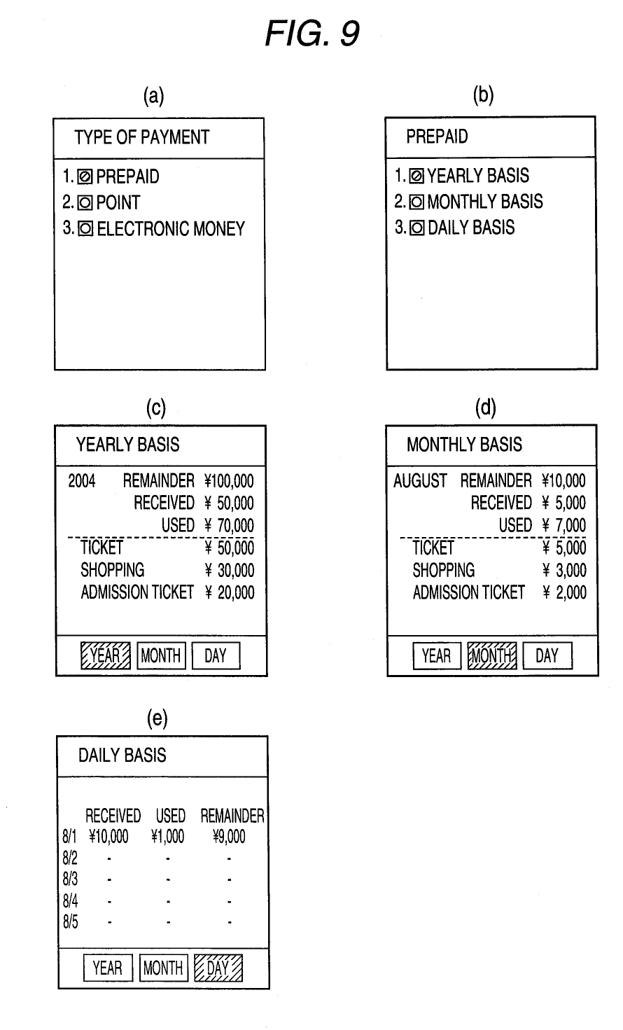

### BRIEF DESCRIPTION OF THE DRAWINGS

[FIG. 1] A configurative view of a mobile terminal device according to a first embodiment of the present invention.

[FIG. 2] A flowchart in outputting a service utilizing situation by a noncontact IC, in the mobile terminal device according to the first embodiment of the present invention.

[FIG. 3] A configurative view of a mobile terminal device according to a second embodiment of the present invention.

[FIG. 4] A flowchart in outputting a service utilizing situation by a noncontact IC, in the mobile terminal device according to the second embodiment of the present invention.

[FIG. 5] A flowchart in outputting a service utilizing situation by a noncontact IC, in a mobile terminal device according to a third embodiment of the present invention.

[FIG. 6] An example of conditions applied to search a utilizing situation of a predetermined service, which is displayed on a displaying portion of the mobile terminal device according to the third embodiment of the present invention.

[FIG. 7] Display Examples 1 of utilizing situations of respective services, which are displayed on the displaying portion of the mobile terminal device according to the third embodiment of the present invention.

[FIG. 8] Display Examples 2 of utilizing situations of respective services, which are displayed on the displaying portion of the mobile terminal device according to the third embodiment of the present invention.

[FIG. 9] Display Examples 3 of utilizing situations of respective services, which are displayed on the displaying portion of the mobile terminal device according to the third embodiment of the present invention.

### DESCRIPTION OF REFERENCE NUMERALS AND SIGNS

1 controlling portion
2 noncontact IC
21 CPU of the noncontact IC
22 memory of the noncontact IC
23 antenna of the noncontact IC
3 sensing portion
4 memory
5 operation key
6 displaying portion
7 radio portion
8 antenna of a mobile terminal device
9 timer

### BEST MODE FOR CARRYING OUT THE INVENTION

### First Embodiment

A mobile terminal device of a first embodiment of the present invention will be explained in detail with reference to the drawings hereinafter. FIG. 1 shows a configurative view of the mobile terminal device of the first embodiment.

The mobile terminal device of the first embodiment of the present invention is constructed to include a controlling portion 1 for controlling functions of the mobile terminal device and executions of applications executable by the mobile terminal device, a noncontact IC 2 for making it possible for the user of the mobile terminal device to utilize various services, a sensing portion 3 for sensing an operation condition of the noncontact IC 2, a memory 4 for storing various data, an operation key 5 for accepting an input operation from the user of the mobile terminal device, a displaying portion 6 for displaying various information, and a radio portion 7 for holding radio communication via an antenna 8 of the mobile terminal device.

The controlling portion 1 is connected to the noncontact IC 2, the sensing portion 3, the memory 4, the operation key 5, the displaying portion 6, and the radio portion 7, and controls execution processes of respective portions by running programs stored in the memory 4.

The noncontact IC 2 means a chip card in which an IC is built, and is constructed by a CPU 21, a memory 22, and an antenna 23. The noncontact IC 2 has no contact, and a power supply and data communication are carried out by using the antenna 23. This noncontact IC is also called an “RF-ID (Radio Frequency Identification)” or an “RF tag” depending on the usage, but basically these cards means the identical card. Also, the noncontact IC 2 is often utilized in a credit transaction or a settlement when the powerful CPU 21 is installed.

The sensing portion 3 outputs a sense signal to the controlling portion 1 by sensing the fact the noncontact IC 2 is being utilized in a certain service by the user of the mobile terminal device. More particularly, the sensing portion 3 senses the fact the noncontact IC 2 is being utilized in the service by the user of the mobile terminal device, based on the event that an interrupt signal is input into the controlling portion 1 from the noncontact IC 2 because the noncontact IC 2 gets into communication with the reader/writer, an oscillation of a clock of the noncontact IC 2 is started because a radio wave used for communication with the reader/writer is received by the antenna 23, or change of a voltage supplied to the noncontact IC 2 is sensed because a power is consumed in a signal processing of the CPU 21 of the noncontact IC 2, for example.

The controlling portion 1, when received the sense signal from the sensing portion 3, starts applications for various services respectively to read the data from the memory 22 of the noncontact IC 2. After respective applications are started, the controlling portion 1 reads the data concerning the application conditions of the service corresponding to the application from the memory 22 of the noncontact IC 2 respectively and writes the data into the memory 4 of the mobile terminal device. The data concerning the application conditions of the service contain receipt/payment of money or balance, the number of points that can be utilized in this service instead of a money, access status, and the like.

When the controlling portion 1 senses that the operation key 5 accepts the operation that instructs the displaying portion 6 to display the utilization condition of each service while writing the utilization condition of each service stored in the memory 22 of the noncontact IC 2 into the memory 4 of the mobile terminal device as above, such controlling portion 1 reads the utilization condition of each service from the memory 4 of the mobile terminal device and controls the displaying portion 6 to display them. An example of the utilization condition of each service displayed on the displaying portion 6 will be described later.

Also, the controlling portion 1 sends a mail of the utilization condition of each service read from the memory 4 of the mobile terminal device to a destination that the user of the mobile terminal device sets previously by referring to a phone book function, or the like via the radio portion 7. The controlling portion 1 may send the utilization condition of each service read from the memory 4 of the mobile terminal device by a mail every time when the utilization condition of each service is written into the memory 4 of the mobile terminal device, or the controlling portion 1 may send the utilization condition of each service read from the memory 4 of the mobile terminal device by a mail every time when the utilization condition of each service is written predetermined times.

Next, a flow of processes in the mobile terminal device of the first embodiment of the present invention will be explained hereunder. A flowchart in outputting a service utilizing situation by a noncontact IC, in the mobile terminal device of the first embodiment of the present invention is shown in FIG. 2.

In the mobile terminal device of the first embodiment of the present invention, the user of the mobile terminal device starts the utilization of the service that is available by the noncontact IC 2. Based on the event that an interrupt signal is input into the controlling portion 1 from the noncontact IC 2 because the noncontact IC 2 gets into communication with the reader/writer, an oscillation of a clock of the noncontact IC 2 is started because a radio wave used for communication with the reader/writer is received by the antenna 23, or change of a voltage supplied to the noncontact IC 2 is sensed because a power is consumed in a signal processing of the CPU 21 of the noncontact IC 2, for example, the sensing portion 3 senses that the noncontact IC 2 is holding communication with the reader/writer (S21, YES).

The noncontact IC 2 stores the updated utilization condition in the memory 22 of the noncontact IC 2 every time when data concerning the utilization condition of the service are transmitted from the reader/writer in response to the service that the user of this mobile terminal device used (S22).

If the sensing portion 3 senses that the noncontact IC 2 ends the communication with the reader/writer (S23, YES), such sensing portion 3 outputs a sense signal to the controlling portion 1. Then, the controlling portion 1 starts applications of various services respectively to read the utilization condition from the memory 22 of the noncontact IC 2 (S24). After respective applications are started, the controlling portion 1 reads data regarding the utilization condition of the service corresponding to the application from the memory 22 of the noncontact IC 2 (S25). Then, the controlling portion 1 writes the data regarding the utilization condition in the memory 4 of the mobile terminal device (S26). Here, it is set forth that the controlling portion 1 should execute the processes from step 24 to step 26 every time when the sensing portion 3 senses that the noncontact IC 2 ends the communication with the reader/writer. But the controlling portion 1 may execute the processes from step 24 to step 26 at a point of time when the sensing portion 3 senses that the noncontact IC 2 completed the communication with the reader/writer predetermined number of times after the user of the mobile terminal device utilized the service that is available by the noncontact IC 2 predetermined number of times.

If the controlling portion 1 senses that the operation key 5 accepts the operation to cause the displaying portion 6 to display the utilization condition of each service (S27, YES), such controlling portion 1 reads the utilization condition of each service from the memory 4 of the mobile terminal device and controls the displaying portion 6 to display the condition (S28). Also, if the controlling portion 1 senses that the operation key 5 accepts the operation to cause the radio portion 7 to send the utilization condition of each service by a mail (S27, YES), such controlling portion 1 reads the utilization condition of each service from the memory 4 of the mobile terminal device and controls the radio portion 7 to send a mail (S28). Here, it is set forth that, when the controlling portion 1 receives the operation in step 27 to output the utilization condition of each service via the operation key 5, such controlling portion 1 reads the utilization condition of each service from the memory 4 of the mobile terminal device and outputs the condition in step 28. But the controlling portion 1 may read the utilization condition of each service from the memory 4 of the mobile terminal device and output the condition every time when the utilization condition of each service is written into the memory 4 of the mobile terminal device in step 26 (S28).

In the mobile terminal device equipped with the noncontact IC in the prior art, in checking the application condition of each service that is available by the noncontact IC, the application for reading the data corresponding the service must be started one by one every time when the user of the mobile terminal device executes the operation to output the application condition of each service and the data regarding the application condition of each service are read from the noncontact IC and output. In contrast, in the mobile terminal device of the first embodiment of the present invention, the application for reading the data corresponding each service is started every time when the noncontact IC is utilized in any service, then the data regarding the application condition of each service are read from the noncontact IC and stored in the storing portion of the mobile terminal, and then the stored data regarding the application condition of each service are output when the user of the mobile terminal device executes the operation to output the application condition of the service. Therefore, a time required to output the application condition of each service since the operation of the user of the mobile terminal device can be reduced. Also, the data regarding the application conditions of plural services are read from the noncontact IC and stored. Therefore, the data of these application conditions can be easily managed and the application conditions of plural services can be displayed simultaneously.

### Second Embodiment

A mobile terminal device of a second embodiment of the present invention will be explained in detail with reference to the drawings hereinafter. A configurative view of a mobile terminal device of a second embodiment of the present invention is shown in FIG. 3. In the mobile terminal device of the second embodiment of the present invention, the sensing portion 3 does not sense the operation condition of the noncontact IC 2 unlike the mobile terminal device of the first embodiment of the present invention, but senses a timer signal input from a timer 9 and outputs a sense signal to the controlling portion 1. The timer 9 outputs the timer signal to the sensing portion 3 based on information of a time in such a manner that the timer 9 outputs the timer signal to the sensing portion 3 at a predetermined time interval, the timer 9 outputs the timer signal to the sensing portion 3 at a pointed time, or the like. Other configurations are same as those of the mobile terminal device of the first embodiment of the present invention.

Next, a flow of processes in the mobile terminal device of the second embodiment of the present invention will be explained hereunder. A flowchart in outputting a service utilizing situation by the noncontact IC, in the mobile terminal device of the second embodiment of the present invention is shown in FIG. 4.

In the mobile terminal device of the second embodiment of the present invention, the timer 9 outputs the timer signal to the sensing portion 3 when a predetermined time has elapsed or when a scheduled time has come, and the sensing portion 3 senses the signal input from the timer 9 to output the sense signal to the controlling portion 1 (S31, YES).

When the sensing portion 3 outputs the sense signal to the controlling portion 1, the controlling portion 1 starts applications of various services respectively to read the data from the memory 22 of the noncontact IC 2 (S32). After respective applications are started, the controlling portion 1 reads the data regarding the utilization condition of the service corresponding to the application from the memory 22 of the noncontact IC 2 (S33). Then, the controlling portion 1 writes the data of the utilization condition in the memory 4 of the mobile terminal device (S34).

When the controlling portion 1 senses that that the operation key 5 accepts the operation to display the utilization condition of each service on the displaying portion 6 (S35, YES), it reads the utilization condition from the memory 4 of the mobile terminal device and controls the displaying portion 6 to display the condition (S36). Also, when the controlling portion 1 senses that that the operation key 5 accepts the operation to send the utilization condition of each service by a mail via the radio portion 7 (S35, YES), it reads the utilization condition from the memory 4 of the mobile terminal device and controls the radio portion 7 to send a mail (S36). Here, it is set forth that, when the controlling portion 1 receives the operation in step 35 to output the utilization condition of each service via the operation key 5, such controlling portion 1 reads the utilization condition of each service from the memory 4 of the mobile terminal device and outputs the condition in step 36. But the controlling portion 1 may read the utilization condition of each service from the memory 4 of the mobile terminal device and output the condition every time when the utilization condition of each service is written into the memory 4 of the mobile terminal device in step 34 (S36).

In the mobile terminal device of the second embodiment of the present invention, the application for reading the data corresponding each service is started at a predetermined time interval or at a scheduled time, then the data regarding the application condition of each service are read from the noncontact IC and stored in the storing portion of the mobile terminal, and then the stored data regarding the application condition of each service are output when the user of the mobile terminal device executes the operation to output the application condition of the service. Therefore, a time required to output the application condition of each service since the operation of the user of the mobile terminal device can be reduced. Also, the data regarding the application conditions of plural services are read from the noncontact IC and stored. Therefore, the data of these application conditions can be easily managed and the application conditions of plural services can be displayed simultaneously.

### Third Embodiment

A mobile terminal device of a third embodiment of the present invention will be explained in detail with reference to the drawings hereinafter. As a configurative view of a mobile terminal device of a third embodiment of the present invention, the configuration shown in either FIG. 1 or FIG. 2 may be employed.

In the mobile terminal device of the third embodiment of the present invention, the operation key 5 accepts the conditions to output only the utilization condition of a particular service upon outputting the utilization condition of the service available by the noncontact IC from the memory 4 of the mobile terminal device in the process in step 28 in FIG. 2 in the mobile terminal device of the first embodiment of the present invention or in the process in step 36 in FIG. 4 in the mobile terminal device of the second embodiment of the present invention. The operation key 5 accepts the conditions such as the type of service, the time and money used in the service, the terms of payment of the utilized service, and the like, for example. The controlling portion 1 reads the utilization conditions of respective services, which meet the conditions accepted by the operation key 5, from the memory 4 of the mobile terminal device and outputs the utilization conditions. Other configurations are same as those of the mobile terminal device of the first embodiment of the present invention or those of the mobile terminal device of the second embodiment of the present invention.

Next, a flow of processes in the mobile terminal device of the third embodiment of the present invention will be explained hereunder. A flowchart in outputting a service utilizing situation by the noncontact IC, in the mobile terminal device of the third embodiment of the present invention is shown in FIG. 5. Since the flow of processes in the mobile terminal device of the third embodiment of the present invention is partially common to the processes in steps 21 to 27 in FIG. 2 in the mobile terminal device of the first embodiment of the present invention or the processes in steps 31 to 35 in FIG. 4 in the mobile terminal device of the second embodiment of the present invention, their flowchart will be omitted herein.

After the process in step 21 in FIG. 2 or the process in step 35 in FIG. 4, the controlling portion 1 accepts the conditions to search the utilization condition for a predetermined service via the operation key 5 (S51). Then, the controlling portion 1 searches the utilization condition for the concerned service, which meets the accepted conditions, from the memory 4 of the mobile terminal device (S52). Then, the controlling portion 1 reads the utilization condition for the concerned service from the memory 4 of the mobile terminal device (S53). The processes in steps 51 to 53 will be explained in detail with reference to an example of the condition shown in FIG. 6 to search the utilization condition of the predetermined service and an example of the utilization conditions of respective services displayed on the displaying portion 6 and shown in FIG. 7 to FIG. 9. Respective conditions to which references 7a to 7f, 8a to 8f, and 9a to 9e shown in FIG. 6 are affixed are displayed on the displaying portion 6 in FIG. 7 to FIG. 9.

The controlling portion 1 causes the displaying portion 6 to display the conditions to which the references 7a to 7f, 8a to 8f, and 9a to 9e shown in FIG. 6 are affixed as shown in FIG. 7 to FIG. 9 respectively, and then causes the displaying portion 6 to display the utilization condition of the services that meet the selected conditions when the conditions are selected by the user of the mobile terminal device via the operation key 5. Since a screen of the displaying portion 6 calls upon the user of the mobile terminal device to select the conditions that are applied to search the utilization condition of the predetermined service, the user of the mobile terminal device can input effectively the conditions.

A flow of conditions shown in FIG. 6 will be explained hereunder. When the controlling portion 1 senses that the user of the mobile terminal device starts the operation to check the utilization condition of the service that is utilized by the noncontact IC 2 via the operation key 5, it displays a main menu to check the utilization condition of the service shown in FIG. 7(a). An item “Total” is the condition applied to check a utilization condition list of all services that are available by the noncontact IC. An item “service oriented” is the condition applied to check the utilization condition of each service that is available by the noncontact IC. An item “type of payment” is the condition applied to check the utilization condition every terms of payment that is available by the noncontact IC.

When the controlling portion 1 senses that the item “Total” is selected by the user of the mobile terminal device, it causes the displaying portion to display another condition shown in FIG. 7(b) and calls upon the user of the mobile terminal device to select either a balance list of all services or utilization histories of all services. When the controlling portion 1 senses that the item “balance list” is selected by the user of the mobile terminal device, it reads utilization histories of respective services from the memory 4 of the mobile terminal device. Then, the controlling portion 1 calculates balances of respective services and displays the balance list shown in FIG. 7(c) on the displaying portion 6. Also, when the controlling portion 1 senses that the item “utilization history” is selected by the user of the mobile terminal device, it causes the displaying portion 6 to display a calendar to point a date shown in FIG. 7(d), and calls upon the user of the mobile terminal device to input another condition. When the controlling portion 1 senses that a certain date (here, August 18) is pointed by the user of the mobile terminal device, it reads the utilization conditions of respective services on the pointed date from the memory 4 of the mobile terminal device and then displays the utilization history shown in FIG. 7(e). In contrast, when the controlling portion 1 senses that a certain month (here, August) is pointed by the user of the mobile terminal device, it reads the utilization conditions of respective services in the pointed month from the memory 4 of the mobile terminal device and then displays the utilization history shown in FIG. 7(f).

Also, when the controlling portion 1 senses that the item “service oriented” shown in FIG. 7(a) is selected by the user of the mobile terminal device, it displays respective service names that are available by the noncontact IC shown in FIG. 8(a) and calls upon the user of the mobile terminal device to decide which utilization condition of the service should be displayed. When the controlling portion 1 senses that a prepaid A of the service utilizing a prepaid card is selected by the user of the mobile terminal device, it displays another conditions shown in FIG. 8(b) and calls upon the user of the mobile terminal device to select either the balance of the prepaid A or the utilization history. When the controlling portion 1 senses that the item “balance” is selected by the user of the mobile terminal device, it reads the utilization condition of the prepaid A from the memory 4 of the mobile terminal device. Then, the controlling portion 1 calculates the balance and displays the balance shown in FIG. 8(c) on the displaying portion 6. Also, when the controlling portion 1 senses that the item “utilization history” is selected by the user of the mobile terminal device, it causes the displaying portion to display a calendar used to point a date shown in FIG. 8(d) and calls upon the user of the mobile terminal device to input another condition. When the controlling portion 1 senses that a certain date (here, August 18) is pointed by the user of the mobile terminal device, it reads the utilization conditions of the prepaid A on the pointed date from the memory 4 of the mobile terminal device and then displays the utilization history shown in FIG. 8(e). In contrast, when the controlling portion 1 senses that a certain month (here, August) is pointed by the user of the mobile terminal device, it reads the utilization conditions of the prepaid A in the pointed month from the memory 4 of the mobile terminal device and then displays the utilization history shown in FIG. 8(f).

Also, when the controlling portion 1 senses that the item “type of payment” shown in FIG. 7(a) is selected by the user of the mobile terminal device, it causes the displaying portion to display respective terms of payment that are available by the noncontact IC shown in FIG. 9(a), and calls upon the user of the mobile terminal device to decide which terms of payment should be displayed for the utilization condition of the utilized service. When the controlling portion 1 senses that the prepaid is selected as the terms of payment by the user of the mobile terminal device, it causes the displaying portion to display another condition shown in FIG. 9(b), and calls upon the user of the mobile terminal device to decide which utilization history out of a yearly basis, a monthly basis, and a daily basis should be displayed. The controlling portion 1 reads the utilization conditions of all services used by the prepaid in response to a yearly basis, a monthly basis, and a daily basis selected from the memory 4 of the mobile terminal device, and displays the utilization history shown FIG. 9(c), FIG. 9(d), or FIG. 9(e).

In the mobile terminal device of the third embodiment of the present invention, the application for reading the data corresponding each service is started every time when the noncontact IC is utilized in any service or at a predetermined time interval or a predetermined time, then the data regarding the application condition of each service are read from the noncontact IC and stored in the storing portion of the mobile terminal, and then the stored data regarding the application condition of each service are output when the user of the mobile terminal device executes the operation to output the application condition of the service. Therefore, the user of the mobile terminal device can check effectively only the utilization condition of the service that the user wishes to check.

The present invention is explained in detail with reference to the particular embodiments. But it is apparent for those skilled in the art that various variation and modifications can be applied without departing from a spirit and a scope of the present invention.

This application is based upon Japanese Patent Application (Patent Application No. 2004-350970) filed on Dec. 3, 2004; the contents of which are incorporated herein by reference.

### INDUSTRIAL APPLICABILITY

The mobile terminal device of the present invention possesses such an advantage that convenience of the noncontact IC user in checking the utilization history of services that utilize the noncontact IC can be improved, and is useful to the mobile terminal device in which the noncontact IC is installed and, more particularly, the mobile terminal device capable of checking the utilization history of services that are available by the noncontact IC.

1. A mobile terminal device having a noncontact IC which is available in various services, comprising:
an acquiring unit that acquires utilization conditions of various services stored in the noncontact ID;
a storing unit that stores acquired utilization conditions of various services;
an outputting unit that outputs the utilization conditions of various services stored in the storing unit; and
a timing notifying unit that outputs a timing signal to the acquiring unit to acquire the utilization conditions of various services,
wherein the acquiring unit acquires the utilization conditions of various services stored in the noncontact IC at a point of time when the timing signal is input from the timing notifying unit.

2. The mobile terminal device according to claim 1, wherein the timing notifying unit outputs the timing signal at a point of time when the noncontact IC is utilized in various services.

3. The mobile terminal device according to claim 2, wherein the timing notifying unit outputs the timing signal at a point of time when the contact IC is utilized in various services predetermine number of times.

4. The mobile terminal device according to claim 1, wherein the timing notifying unit outputs the timing signal at a previously scheduled time or at a previously set time interval.

5. The mobile terminal device according to claim 1, further comprising:
a searching unit that searches the utilization conditions of various services, which coincide with predetermined conditions, from the utilization conditions of various services stored in the storing unit; and
a setting unit that sets the predetermined conditions,
wherein the outputting unit outputs the utilization conditions of various services searched by the searching unit.

6. The mobile terminal device according to claim 1, wherein the outputting unit includes a mail sending unit; and
wherein the mail sending unit sends the utilization conditions of various services stored in the storing unit by a mail.
